(19) United States
(12) Patent Application Publication
(10) Pub. No.: US 2017/0368729 A1
(43) Pub. Date: Dec. 28, 2017

(54) MANUFACTURING METHOD OF WIRE HARNESS

(71) Applicants: YAZAKI CORPORATION, Tokyo (JP); TOYOTA JIDOSHA KABUSHIKI KAISHA, Toyota-shi (JP)

(72) Inventors: Kimitoshi MAKINO, Makinohara-shi (JP); Tetsuro SAIMOTO, Makinohara-shi (JP); Akihito SHIBUYA, Makinohara-shi (JP); Naoya KAWASAKI, Toyota-shi (JP); Masaaki SUGIYAMA, Toyota-shi (JP); Masataka YAMAMOTO, Makinohara-shi (JP); Kenji KINEZUKA, Kakegawa-shi (JP); Shinya MATSUURA, Kakegawa-shi (JP); Yasuhiro SUZUKI, Kakegawa-shi (JP); Takafumi MORI, Makinohara-shi (JP); Takenori TSUCHIYA, Toyota-shi (JP)

(73) Assignees: YAZAKI CORPORATION, Tokyo (JP); TOYOTA JIDOSHA KABUSHIKI KAISHA, Toyota-shi (JP)

(21) Appl. No.: 15/630,096

(22) Filed: Jun. 22, 2017

(30) Foreign Application Priority Data
Jun. 23, 2016 (JP) 2016-124874

(51) Int. Cl. B29C 45/14; H01B 7/00; H01B 13/06; H01B 13/012; B29C 45/00; B29L 31/34; B29K 23/00

(52) U.S. Cl. CPC B29C 45/14639; B29C 45/14008; H01B 13/01209; H01B 7/0045; B29C 45/0025; H01B 13/06; B29C 2045/0044; B29K 2023/12; B29L 2031/3462

(57) ABSTRACT

A manufacturing method of a wire harness which includes at least one bundle of an electric wire group in which a plurality of electric wires are linearly arranged, and a damming part made of a resin material surrounding a part of the electric wire group in an extending direction of the electric wire group and including an outer periphery shape part according to an inner peripheral shape of an electric wire group insertion part, the manufacturing method includes a mold clamping step of disposing a part of the one bundle of the electric wire group and mold clamping an upper mold and a lower mold and an injection step of performing low pressure injection of a larger amount of molten resin than a volume of a cavity into the cavity.

### CROSS REFERENCE TO RELATED APPLICATIONS

This application claims priority from Japanese Patent Application No. 2016-124874 filed on Jun. 23, 2016, the entire contents of which are incorporated herein by reference.

### BACKGROUND OF THE INVENTION

### Field of the Invention

The present invention relates to the manufacturing method of a wire harness.

### Description of Related Art

For water stop structures of a wire harness in which a plurality of electric wires are bundled, there are those which use a single liquid water stop (silicone), butyl rubber, or the like. As illustrated in FIG. 14A, in the water stop structure using the single liquid water stop, an electric wire bundle is divided into individual electric wires 501, and a silicon 503 is applied, caused to conform, formed, and solidified. The outer periphery of the solidified silicon 503 is covered by a sheet member 505. In the wire harness to which the water stop structure is applied in this manner, a grommet 507 is externally fitted to the outer periphery of the sheet member 505. The grommet 507 waterproofs a space between the sheet member 505 and a harness insertion hole (not illustrated) such as a vehicle body panel.

As illustrated in FIG. 14B, the water stop structure which uses the butyl rubber is such that the electric wire bundle is divided into the individual electric wires 501, placed on a butyl rubber 509, the butyl rubber 509 and the electric wires 501 are laid repeatedly, and the spaces between the electric wires are filled with the butyl rubber 509 under pressure and formed. An adhesive tape 511 is wound around the outer periphery of the butyl rubber 509. In the wire harness to which the water stop structure is applied in this manner, a seal sponge 513 is wound around the outer periphery of the adhesive tape 511. The seal sponge 513 waterproofs the space between the adhesive tape 511 and the harness insertion hole (not illustrated).

### [Patent Document 1] JP-A-2011-172412

According to a related art, in a water stop structure by a one-component water stop, a gap between the electric wires is filled with a water stop agent (silicon 503), and the water stop agent adheres to the electric wire coating. Therefore, although the water stop performance is excellent, since it is difficult to manage the water stop agent and several hours are necessary for the water stop agent to solidify, workability is not good. In the water stop structure which uses the butyl rubber 509 described above, the spaces between the electric wires are filled with the water stop agent (the butyl rubber 509), and since the butyl rubber itself is soft, easily conformable, and yet has adhesiveness, if the filling is reliably performed, the water stop performance is excellent; however, there is a problem in that it is difficult to control the amount of butyl rubber which is used. Furthermore, the water stop structure which uses the butyl rubber 509 has poor workability such that the butyl rubber 509 is sticky and sticks to hands, and it is difficult to confirm the filling status.

As a technique capable of being applied to a water stop structure, a mold structure is known in which the outer periphery of an electric wire bundle is molded with a resin material (refer to Patent Document 1 or the like). However, with such a mold structure, when three or more electric wires are bundled, gaps (resin unfilled space) are formed which are spaces between adjacent electric wires which may not be filled with resin. Such a resin unfilled space may not be visually observed from the outside, and it is extremely difficult to determine to what extent the resin can be filled tightly in small gaps between the electric wires. Although it is possible to measure gaps by conducting a destructive inspection, it is only a sampling inspection, and it is impossible to inspect all the products. In all of these mold structures, the molding is performed using an ordinary injection molding machine. Therefore, facilities become large-scaled.

### SUMMARY

One or more embodiments provide a manufacturing method of a wire harness which is capable of easily suppressing a water entrance amount which infiltrates from an electric wire group insertion part.

### Means for Solving the Problem

In an aspect (1), one or more embodiments provide a manufacturing method of a wire harness which includes at least one bundle of an electric wire group in which a plurality of electric wires are linearly arranged, and a damming part made of a resin material, wherein the damming part surrounds a part of the electric wire group in an extending direction of the electric wire group, and wherein the damming part includes an outer periphery shape part according to an inner peripheral shape of an electric wire group insertion part, the manufacturing method including disposing a part of the one bundle of the electric wire group in a harness housing part and mold clamping an upper mold and a lower mold in which the harness housing part is formed on a pair of divided surfaces, and performing low pressure injection of a larger amount of molten resin than a volume of a cavity into the cavity, so that the resin material with which the cavity is filled protrudes from gaps between flat deburring surfaces and adjacent electric wires. The harness housing part includes the cavity so as to mold the damming part and includes the flat deburring surfaces which clamp an outer periphery of the one bundle of the electric wire group at both outside end parts of the cavity which face each other in the extending direction of the electric wire group.

According to the aspect (1), a single row electric wire group is disposed in a harness housing part, and when mold clamping an upper mold and a lower mold which are aligned so as to interpose the single row electric wire group in parallel with flat deburring surfaces which are formed on both outside end parts of a cavity which runs along an extending direction of the electric wire group, a molding space for molding a damming part is defined between the upper mold and the lower mold. With the gaps which are formed between the flat deburring surfaces and the spaces between the adjacent electric wires remaining vacant, a greater amount of the molten resin than the volume of the cavity is injected at low pressure into the cavity. As a result, the excess part of the molten resin with which the cavity is filled protrudes from the gaps between the flat deburring surfaces and the spaces between the adjacent electric wires. Here, since the gaps between the electric wires in the cavity are larger than the gaps which are formed between the flat deburring surfaces and the spaces between the adjacent electric wires, it is possible to assume that the gaps between the electric wires in the cavity are filled with the molten resin due to the molten resin protruding from the gaps between the flat deburring surfaces and the spaces between the adjacent electric wires. In other words, by visually observing the resin material (the burrs) protruding from the gaps between the electric wires through side surface and the spaces between the adjacent electric wires in the damming part, it is possible to confirm that the gaps between the electric wires in the damming part are filled with the resin material. Since the molten resin which enters the cavity has low pressure during press fitting and does not leak out from the gaps between the flat deburring surfaces and the spaces between the adjacent electric wires until the cavity is filled, a large amount of the resin will not leak out from the gaps between the flat deburring surface and the spaces between the adjacent electric wires.

In an aspect (2), the resin material includes polypropylene.

According to the aspect (2), by using polypropylene which has excellent hinge characteristics as the resin material, the resin material which protrudes from the gaps does not easily bend and fall, and the resin material does not scratch the electric wire coating, and does not fall to become foreign matter.

According to the manufacturing method of a wire harness according to the present invention, it is possible to easily suppress a water entrance amount which infiltrates from an electric wire group insertion part.

The invention has been briefly described above. Further, the details of the invention will become more apparent by reading the embodiments for carrying out the invention (hereinafter referred to as the “exemplary embodiments”) described hereinafter with reference to the attached drawings.

### BRIEF DESCRIPTION OF THE DRAWINGS

FIGS. 1A and 1B represent a water entrance countermeasure structure of a wire harness according to a first exemplary embodiment. FIG. 1A is a perspective diagram in which a damming part is provided in a single stage electric wire group, and FIG. 1B is an enlarged diagram of an A part in FIG. 1A.

FIG. 2 is a sectional diagram of a damming part illustrated in FIG. 1A taken along an II-II line.

FIG. 3 is a sectional diagram of the main parts in the vicinity of a deburring surface in a state in which a cavity of a mold is filled with a molten resin.

FIG. 4 is an exploded perspective diagram of the main parts representing a device connection structure which uses a wire harness which is provided with the water entrance countermeasure structure illustrated in FIG. 1A.

FIG. 5 is a perspective diagram of a low pressure injection molding machine.

FIG. 6A is a schematic sectional diagram for explaining a state in which a single row electric wire group is covered with a resin material. FIG. 6B is a schematic sectional diagram explaining a state in which an electric wire group in which three or more electric wires are bundled is covered with a resin material.

FIG. 7A is a perspective diagram of a damming part according to a second exemplary embodiment. FIG. 7B is a lateral sectional diagram of the damming part illustrated in FIG. 7A. FIG. 7C is an enlarged diagram of a B part in FIG. 7B.

FIG. 8 is an exploded perspective diagram of the main parts representing a device connection structure which is provided with a water entrance countermeasure structure of a wire harness according to a third exemplary embodiment.

FIG. 9A is a perspective diagram of the damming part illustrated in FIG. 8. FIG. 9B is a lateral sectional diagram of a state in which the damming part illustrated in FIG. 9A is fitted into a through hole of the electric wire group insertion part. FIG. 9C is an enlarged diagram of a C part in FIG. 9B.

FIG. 10A is a perspective diagram illustrating a modification example of the damming part illustrated in FIG. 9A. FIG. 10B is a lateral sectional diagram of a state in which the damming part illustrated in FIG. 10A is fitted into the through hole of the electric wire group insertion part. FIG. 10C is an enlarged diagram of a D part in FIG. 10B.

FIG. 11A is a perspective diagram of a damming part according to a fourth exemplary embodiment of the present invention as viewed from a seating surface side. FIG. 11B is a perspective diagram of a modification example of the damming part illustrated in FIG. 11A as viewed from the seating surface side.

FIG. 12A is a perspective diagram of a comparative example of the damming part illustrated in FIG. 11A as viewed from the seating surface side. FIG. 12B is a longitudinal sectional diagram of the damming part illustrated in FIG. 12A. FIG. 12C is a sectional diagram taken along an XII-XII line in FIG. 12B.

FIG. 13A is a perspective diagram of a damming part according to a fifth exemplary embodiment of the present invention. FIG. 13B is a sectional diagram of a state in which the damming part illustrated in FIG. 13A is fitted into the through hole of the electric wire group insertion part taken along an XIII-XIII line.

FIG. 14A is a lateral sectional diagram of a water stop structure which uses a single liquid water stop of the related art. FIG. 14B is a lateral sectional diagram of a water stop structure which uses butyl rubber.

### DETAILED DESCRIPTION

Hereinafter, the exemplary embodiments of the present invention will be described with reference to the drawings.

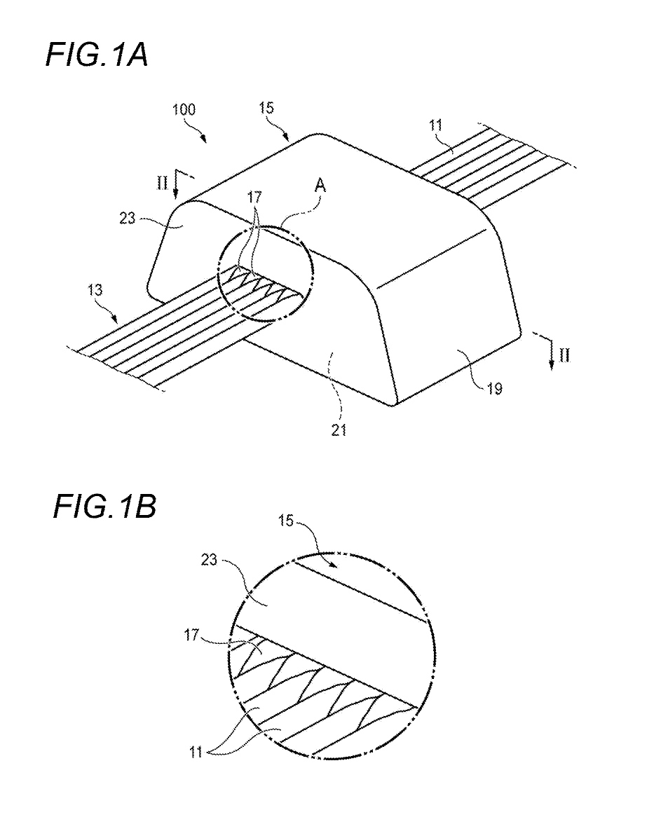

As illustrated in FIG. 1A, the water entrance countermeasure structure of a wire harness 100 according to the first exemplary embodiment of the present invention is provided with an electric wire group 13 and a damming part 15 as the main components, where the electric wire group 13 is formed of a plurality of electric wires 11 which are installed together in a horizontal direction, and the damming part 15 is made of a resin.

The plurality of electric wires 11 are linearly arranged in a row in a diameter direction in the electric wire group 13. In each of the electric wires 11, the outer periphery of the conductor is covered with an insulating resin. The plurality of electric wires 11 is provided so that at least one row lines up in the diameter direction in the electric wire group 13 according to the present invention. The expression “at least one row” means that a plurality of rows may be disposed in a multi-staged formation. However, in this case, as described later, the electric wire group of each stage is disposed separated from those of the other stages.

The damming part 15 is molded integrally to surround a part of the electric wire group 13 in an extending direction. The damming part 15 is integrally molded so as to include an outer periphery shape part 19 corresponding to the inner peripheral shape of an electric wire group insertion part 29 which is described later, and a pair of side surfaces extending along the extending direction of the electric wire group 13. The outer periphery shape part 19 of the damming part 15 can be molded in a trapezoidal cross section taken along a plane which is orthogonal to the extending direction of the electric wire group 13 in the illustrated example, for example. In the damming part 15, the bottom side surface of the trapezoidal cross-sectional shape is a seating surface 21. The outer periphery shape part 19 of the damming part 15 is not limited thereto.

In the damming part 15, the pair of side surfaces which face each other and interpose the seating surface 21 form electric wire through side surfaces 23. The electric wire group 13 penetrates the damming part 15 from one electric wire through side surface 23 toward the other electric wire through side surface 23.

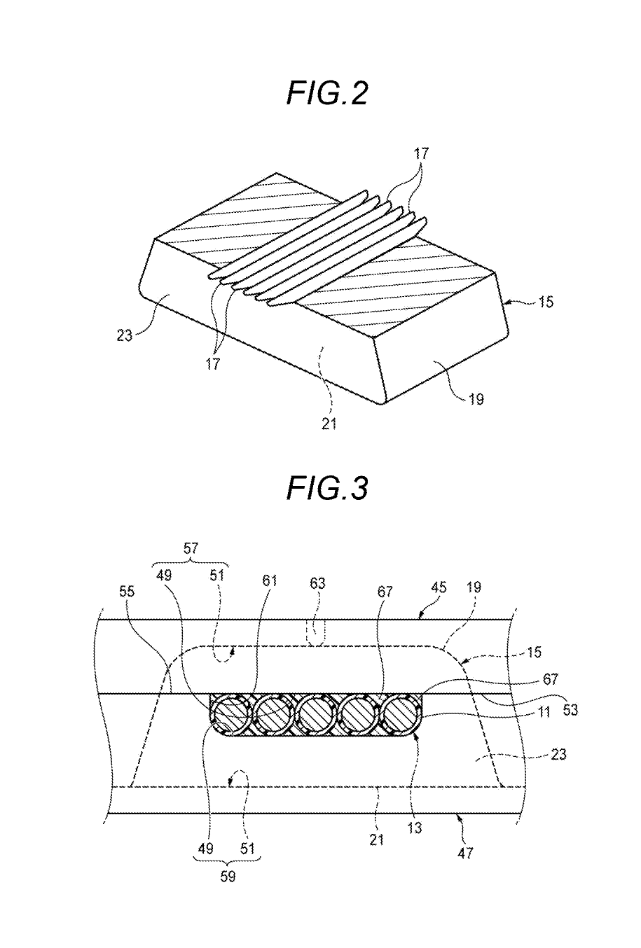

As illustrated in FIGS. 1A and 1B, burrs 17 in which molten resin which overhangs from the mold during the molding of the damming part 15 is solidified are formed between the electric wire through side surfaces 23 and the spaces between the adjacent electric wires 11. As illustrated in FIG. 2, the burrs 17 are formed in the spaces between the respective electric wires 11 on the top surface side and the bottom surface side of the electric wire group 13.

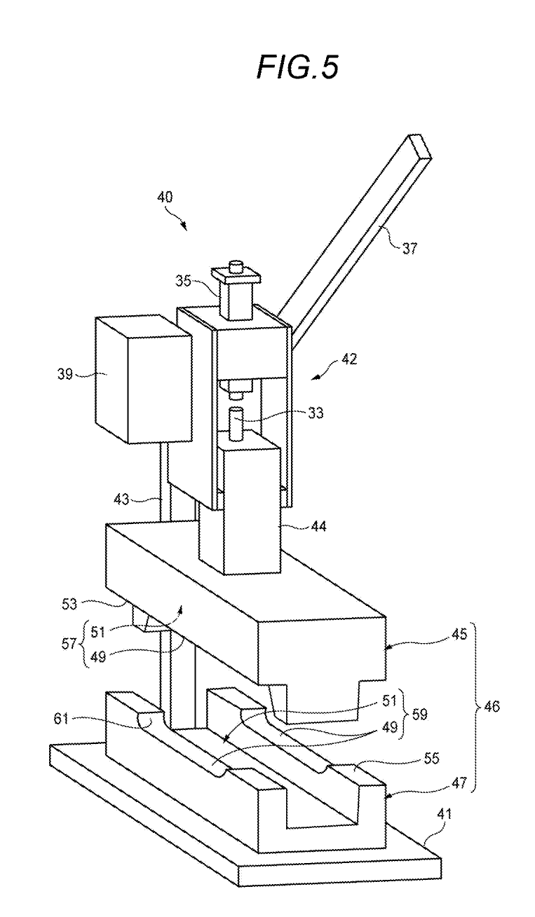

A low pressure injection molding machine 40, which is described later, is used for the molding of the damming part 15 (refer to FIG. 5). In the low pressure injection molding machine 40, for example, general engineering plastics or general purpose plastics (polypropylene or the like) which are resin materials are used. In other words, the water entrance countermeasure structure of the wire harness of the present invention is formed by the electric wire group 13 being insert-molded into the resin material.

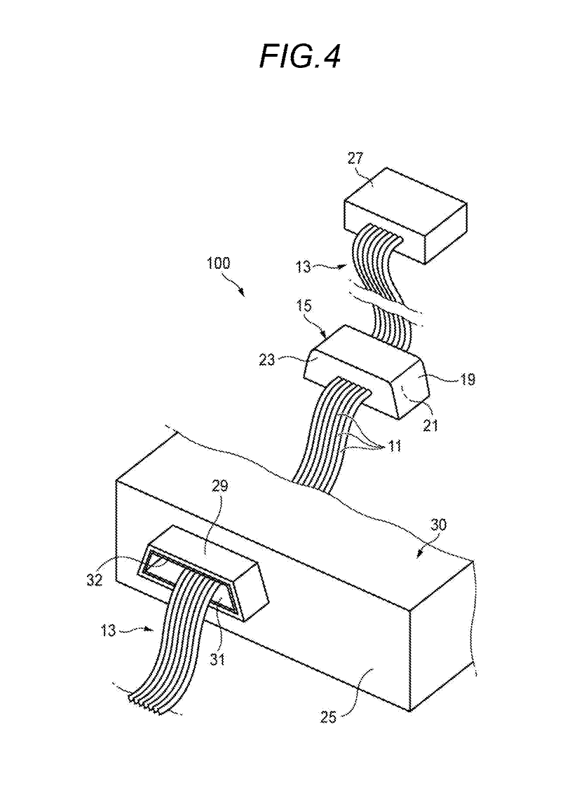

As illustrated in FIG. 4, the electric wire group insertion part 29 through which the electric wire group 13 is passed via the damming part 15 is provided in an integral case (a partition wall part) 25 of a water stop box 30, for example. The electric wire group insertion part 29 is formed in a tubular shape which includes a trapezoidal through hole 31 in a front view. The outer periphery shape part 19 of the damming part 15 is formed so as to have a shape corresponding to the inner peripheral shape of the electric wire group insertion part 29. In this case, the damming part 15 is fitted into the through hole 31 after one end side of the electric wire group 13 is inserted through the through hole 31. In this case, the damming part 15 is formed to have the same sectional shape at an arbitrary position in the insertion direction. A water stop member 32 such as a seal sponge or rubber is bonded to the inner peripheral surface of the through hole 31.

In the damming part 15, the outer periphery shape part 19 may be formed on a tapered surface which is tapered in the insertion direction. Accordingly, it is possible to bring the damming part 15 into closer contact with the inner peripheral surface of the through hole 31 using an insertion pressure into the electric wire group insertion part 29, and it is possible to obtain a high water stop property.

As illustrated in FIG. 4, for example, an electronic device (not illustrated) is housed in the integral case 25 of the water stop box 30. A connector 27 which is connected to one end of the electric wire group 13 is connected to the electronic device. The connector 27 is housed in the integral case 25, and the electric wire group 13 which is led out from the electric wire group insertion part 29 of the integral case 25 is subjected to a water entrance countermeasure by the damming part 15. As a result, the connector 27 is housed in a case which is subjected to a water entrance countermeasure.

In this manner, the water stop box 30 which is provided with the water entrance countermeasure structure of the wire harness 100 according to the first exemplary embodiment is capable of suppressing a water entrance amount which infiltrates the water stop box from the outside of the case via the electric wire group insertion part 29 from which the electric wire group 13 is led out.

FIG. 5 is a perspective diagram of the low pressure injection molding machine 40.

The low pressure injection molding machine 40 for integrally molding the damming part 15 in the electric wire group 13 is a molding machine which can be operated by even a single worker without external power such as an electric motor, and is configured to include a mold 46, a mold clamping device (not illustrated), and the low pressure injection device 42 which pressurizes and injects molten resin into the mold 46.

The low pressure injection device 42 includes a heating cylinder 44, a plunger 33, an injection cylinder 35, a handle 37, and a temperature controller 39, and these are supported by a device support column 43 which is erected on a stand 41. The heating cylinder 44 is provided with a heater for heating and melting a synthetic resin or the like, the plunger 33 injects molten resin in the heating cylinder from a nozzle (not illustrated), the injection cylinder 35 advances the plunger 33, the handle 37 drives the injection cylinder 35, and the temperature controller 39 keeps the heating temperature of the heating cylinder 44 at a desired temperature.

The low pressure injection molding machine 40 in the first exemplary embodiment refers to a device in which the amount of resin that can be molded in one injection molding is about 10 g at maximum, and during the mold clamping of the mold 46, it is possible to manually perform using an air cylinder, a link, or the like. Naturally, the low pressure injection device 42 may drive the injection cylinder 35 using an external power such as an electric motor or air. More specifically, as the low pressure injection molding machine 40, for example, it is possible to use a known “injection molding device” which is disclosed in JP-A-2010-260297, JP-A-2012-30429, and JP-A-2013-103492.

The mold 46 according to the first exemplary embodiment is disposed on the stand 41. In the mold 46, an upper mold 45 and a lower mold 47 are aligned to interpose, so as to house, the electric wire group 13 in deburring surfaces 49 (refer to FIGS. 3 and 5) which are formed at both outside end parts along the extending direction of the electric wire group 13 so that a molding space which serves as a cavity capable of molding the damming part 15 is defined (a mold clamping step).

In other words, in the upper mold 45 and the lower mold 47, harness housing parts 57 and 59 which include a cavity 51 and the deburring surfaces 49 are respectively formed on an upper mold divided surface (a divided surface) 53 and a lower mold divided surface (a divided surface) 55. The cavity 51 is for molding the damming part 15, and the deburring surfaces 49 are flat and interpose the outer periphery of the single row electric wire group 13 on both outside end parts of the cavity 51 which runs along the extending direction (the left-right direction in FIG. 5) of the single row electric wire group 13. The deburring surface 49 of the lower mold 47 has a recessed part capable of housing the single row electric wire group 13, and the depth from the lower mold divided surface 55 is substantially the same as the diameter of the electric wire 11. On the other hand, the deburring surface 49 of the upper mold 45 is formed in a flat plate shape on the same surface as the upper mold divided surface 53.

Therefore, it is possible to mold clamp the upper mold 45 and the lower mold 47 in a state in which the single row electric wire group 13 is housed in the recessed part of the deburring surface 49 in the lower mold 47, the electric wire group 13 is easily disposed in the harness housing part 59, and electric wire biting during the mold clamping does not occur easily.

By supplying a molten resin (molten resin material) 67 from the supply path to the cavity 51 via a gate 63 (refer to FIG. 3), the damming part 15 is molded to the outer periphery of the electric wire group 13.

In the molding which uses the low pressure injection molding machine 40, due to an amount of the molten resin 67 which is greater than the volume of the cavity 51 being injected into the cavity 51 of the mold 46 at a low pressure in a state in which the electric wire group 13 is interposed between the deburring surfaces 49 of the upper mold 45 and the lower mold 47, a predetermined amount of the molten resin (a resin amount of the thermoplastic resin for molding the damming part 15) enters the cavity 51 and, as illustrated in FIG. 3, the excess part of the molten resin 67 protrudes from the gaps which are formed between the flat deburring surfaces 49 and the spaces between the adjacent electric wires 11 (an injection process).

However, the temperature of the molten resin 67 which is injected into the cavity 51 becomes lower toward the injection tip, the curing is promoted, and the mold temperature in the vicinity of the deburring surfaces 49 is less than or equal to the resin melting temperature of the thermoplastic resin. The molten resin 67 which is cured at the injection tip has its own sealing function. Since the low pressure injection device 42 low pressure injects the molten resin 67 into the cavity 51, the molten resin 67 has fluidity, but a degree of fluidity at which the molten resin 67 passes through small gaps between the flat deburring surfaces 49 and the spaces between the adjacent electric wires 11 and a large amount leaks out is suppressed.

As a result, only an excess part of the molten resin with which the inside of the cavity 51 is filled protrudes slightly to form burrs 17 (refer to FIGS. 1A and 1B) without a large amount of the molten resin 67 leaking out from the gaps between the deburring surfaces 49 and the spaces between the adjacent electric wires 11.

Here, the gaps between the electric wires 11 of the electric wire group 13 which is housed in the cavity 51 are larger than the gaps which are formed between the flat deburring surfaces 49 and the spaces between the adjacent electric wires 11. In other words, for example, in a case in which the electric wire 11 is a fine electric wire of 0.35 sq or less, the gaps (opening sectional area) which are formed between the flat deburring surfaces 49 and the spaces between the adjacent electric wires 11 are greatly smaller than the gaps between the electric wires 11 in the cavity 51, and the flow resistance when the molten resin protrudes is large. Therefore, the molten resin 67 which is low pressure injected into the cavity 51 fills the cavity 51 and spreads through the gaps between the electric wires 11, and subsequently only the excess part of the molten resin 67 protrudes from the gaps between the flat deburring surfaces 49 and the spaces between the adjacent electric wires 11.

Therefore, it is possible to assume that the gaps between the electric wires 11 in the cavity 51 are filled with the molten resin 67 due to the molten resin 67 protruding from the gaps between the flat deburring surfaces 49 and the spaces between the adjacent electric wires 11. In other words, by visually observing the burrs protruding from the gaps between the electric wire through side surface 23 and the spaces between the adjacent electric wires 11 in the damming part 15 which is molded, it is possible to confirm that the gaps between the electric wires 11 in the damming part 15 are filled with the resin material.

The mold 46 according to the first exemplary embodiment has a simple structure, and it is possible to reduce the manufacturing cost. Even if the position of the electric wire group 13 which is sandwiched by the deburring surfaces 49 of the upper mold 45 and the lower mold 47 changes a little in the width direction, since the gaps between the deburring surfaces 49 and the electric wire group 13 are sealed with the solidified molten resin, it is possible to flexibly cope with the position change of the electric wire group 13.

Furthermore, a cooling mechanism (not illustrated) which cools the injection tip of the molten resin 67 which is injected into the cavity 51 may be provided in the vicinity of the deburring surfaces 49 in the mold 46. A cooling mechanism is provided on the outside of the mold 46 corresponding to the deburring surfaces 49, for example. Examples of the cooling mechanism include an air cooling system which uses cooling fins or a cold air blower, a water cooling system which works by providing water cooling pipes, electronic cooling which uses a Peltier element, and the like. The temperature at the injection tip of the molten resin 67 can be quickly lowered from an ordinary temperature using the cooling mechanism, and the curing of the molten resin 67 can locally be promoted. In this case, even if the electric wires 11 of the electric wire group 13 which is sandwiched by the deburring surfaces 49 are slightly separated from each other, it is possible to suppress the fluidity from an extent at which a large amount of the molten resin 67 leaks out from the gaps between the electric wires 11, and thus, it is possible to mold the damming part 15 which is free from problems as a product.

In the first exemplary embodiment, the mold 46 is described as a horizontal split type; however, the mold 46 may be a vertical split type.

Next, the operations of the above configuration will be described.

In the water entrance countermeasure structure of the wire harness 100 according to the first exemplary embodiment, a part in the extending direction of the single row electric wire group 13 is surrounded to integrally mold the damming part 15.

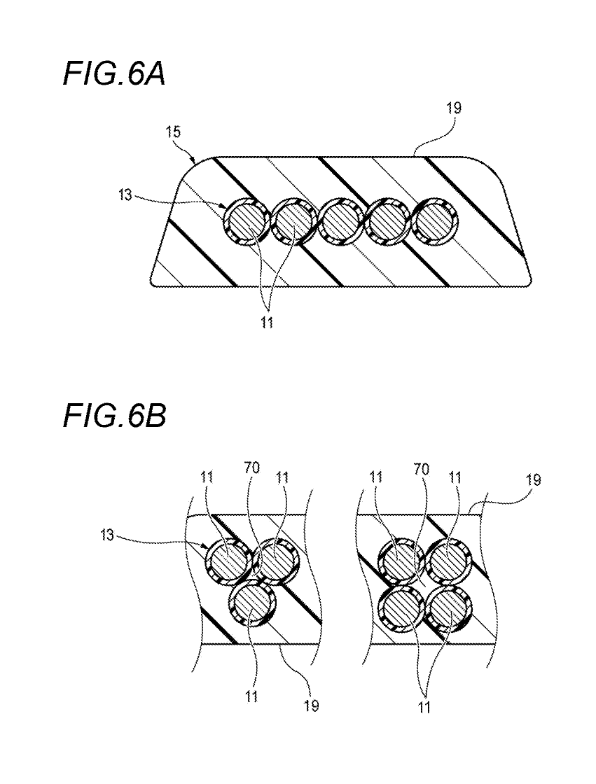

As illustrated in FIG. 6A, the outer periphery shape part 19 of the damming part 15 is molded into a predetermined shape (a trapezoidal cross-sectional shape in the present exemplary embodiment) corresponding to the inner peripheral shape of the electric wire group insertion part 29. In other words, the damming part 15 is formed in a free shape corresponding to the opening shape of the electric wire group insertion part 29.

Since the plurality of electric wires 11 are linearly arranged in a single row in the diameter direction in the electric wire group 13, as illustrated in FIG. 6B, a resin unfilled space 70 which is surrounded by three or more of the electric wires 11 is not formed, and it is possible to reliably perform water entrance countermeasures between the adjacent electric wires 11.

In the water entrance countermeasure structure of the wire harness 100 of the first exemplary embodiment, by selecting polypropylene which has excellent hinge characteristics as the resin material for molding the damming part 15, the burrs 17 which protrude from the gaps do not easily bend and fall, and the burrs 17 do not scratch the electric wire coating, and do not fall to become foreign matter.

The damming part 15 is molded integrally with a low pressure injection molded resin material by the low pressure injection molding machine 40 which is different from an ordinary injection molding machine. In the molding by the low pressure injection molding machine 40, the injection pressure of the molten resin 67 is low as compared with the ordinary injection molding machine. Therefore, it is possible to suppress the influence of heat on the electric wires 11 when molding the damming part 15. The molding by the low pressure injection molding machine 40 can reduce the scale of the equipment as compared with an ordinary injection molding machine.

In this manner, according to the manufacturing method of the wire harness of the first exemplary embodiment, the single row electric wire group 13 is disposed in the harness housing parts 57 and 59, and when mold clamping the upper mold 45 and the lower mold 47 which are aligned so as to interpose the single row electric wire group 13 in parallel with the flat deburring surfaces 49 which are formed on both outside end parts of the cavity 51 which runs along the extending direction of the electric wire group 13, a molding space for molding the damming part 15 is defined between the upper mold 45 and the lower mold 47.

With the gaps which are formed between the flat deburring surfaces 49 and the spaces between the adjacent electric wires 11 remaining vacant, a greater amount of the molten resin 67 than the volume of the cavity 51 is injected at low pressure into the cavity 51. As a result, the excess part of the molten resin 67 with which the cavity 51 is filled protrudes from the gaps between the flat deburring surfaces 49 and the spaces between the adjacent electric wires 11. Here, since the gaps between the electric wires 11 in the cavity 51 are larger than the gaps which are formed between the flat deburring surfaces 49 and the spaces between the adjacent electric wires 11, it is possible to assume that the gaps between the electric wires 11 in the cavity 51 are filled with the molten resin 67 due to the molten resin 67 protruding from the gaps between the flat deburring surfaces 49 and the spaces between the adjacent electric wires 11.

In other words, by visually observing the burrs 17 protruding from the gaps between the electric wire through side surface 23 and the spaces between the adjacent electric wires 11 in the damming part 15 which is molded, it is possible to confirm that the gaps between the electric wires 11 in the damming part 15 are filled with the resin material.

The exemplary embodiment of the damming part according to the present invention is not limited to the damming part 15 in the first exemplary embodiment, and may adopt various forms.

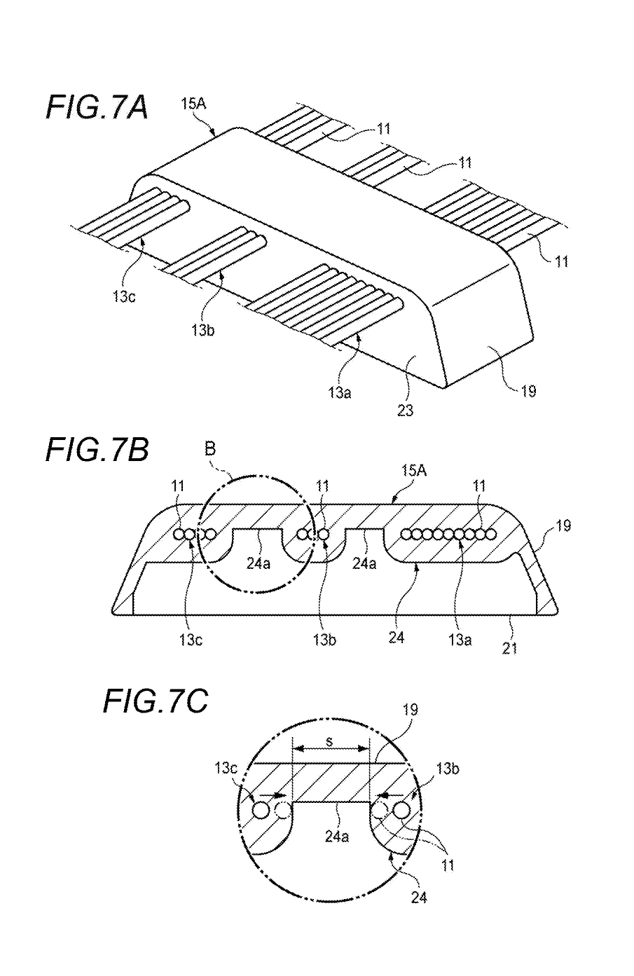

For example, as illustrated in FIG. 7A, a damming part 15A according to the second exemplary embodiment of the present invention includes the outer periphery shape part 19 which surrounds a part of three rows of electric wire groups 13a, 13b, and 13c in the extending direction, and according to the inner peripheral shape of the electric wire group insertion part 29. The three rows of electric wire groups 13a, 13b, and 13c are disposed to be separated by a predetermined interval in the lining up direction of the electric wires 11.

As illustrated in FIG. 7B, in the damming part 15A, a substantially trapezoidal lightening part 24 is recessed in the seating surface 21. The lightening part 24 is formed in the thick part on the side of the seating surface 21 in the damming part 15A, thereby reducing the volume of the thick part and preventing molding defects such as sink marks and voids. Furthermore, in the lightening part 24, lightening recessed parts 24a having a predetermined width are formed so as to be positioned between the rows of electric wire groups 13a, 13b, and 13c.

When the damming part 15A is molded, the lightening part 24 is formed in the seating surface 21 of the damming part 15A by a substantially trapezoidal lightening molding part (not illustrated) which project from the lower mold 47 of the mold 46 (refer to FIG. 4). In other words, when integrally molding the damming part 15A, when the upper mold 45 and the lower mold 47 are mold clamped in a state in which the three rows of the electric wire groups 13a, 13b, and 13c are separated by a predetermined interval and housed in the recessed part of the deburring surfaces 49 in the lower mold 47, the lightening molding part for molding the lightening recessed part 24a is positioned between each of the rows of the electric wire groups 13a, 13b, and 13c in the cavity 51.

Therefore, even if the electric wires 11 flex under the resin pressure of the molten resin 67 which is supplied into the cavity 51, a minimum necessary interval S between each row of the electric wire groups 13a, 13b, and 13c is secured by the lightening molding part of the lower mold 47 as illustrated in FIG. 7C.

Therefore, in a case in which it is necessary to provide a predetermined interval between the plurality of electric wire groups 13a, 13b, and 13c which penetrate the integral case, even if the distance between the electric wire groups 13a, 13b, and 13c is taken into account in the tolerance, by setting the predetermined width of the lightening recessed part 24a in the damming part 15A so as to satisfy the necessary dimensions for the interval, even in a worst case for tolerance, it is possible to secure an interval between the electric wire groups 13a, 13b, and 13c which are buried in the damming part 15A to a level greater than or equal to the necessary distance. The guarantee of the interval between the electric wire groups 13a, 13b, and 13c can be discerned only by visual observation as to whether or not the electric wires 11 are exposed on the resin surface of the lightening part 24.

In a case of a conventional structure in which a plurality of electric wire groups are respectively arranged into a plurality of separate electric wire bundles which are conformed to the water stop member, and subsequently the respective electric wire bundles are passed through the integral case at predetermined intervals, it is necessary to form a plurality of through holes to penetrate the integral case. Conversely, in a case in which the damming part 15A of the second exemplary embodiment is used, one through hole 31 may be formed in the integral case 25, and the degree of freedom in designing the integral case is improved. In the damming part 15A, since the plurality of electric wire groups 13a, 13b, and 13c are buried in the damming part 15A by a single molding, it is possible to obtain a water entrance countermeasure structure.

Furthermore, even in a case in which it is necessary to float the plurality of electric wire groups 13a, 13b, and 13c with respect to a vehicle body frame or the like to which the integral case 25 is fixed, since the damming part 15A which includes the lightening part 24 in the seating surface 21 has a high degree of freedom in the dimension of the height direction, it is possible to easily adapt.

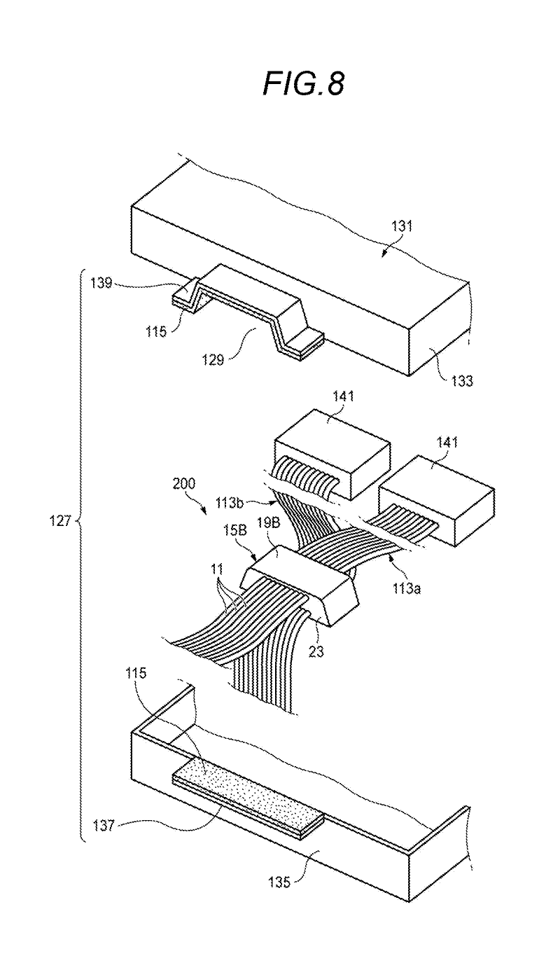

FIG. 8 is an exploded perspective diagram of the main parts representing a device connection structure which is provided with a water entrance countermeasure structure of a wire harness according to the third exemplary embodiment of the present invention.

A wire harness 200 which is provided with the water entrance countermeasure structure of the wire harness according to the third exemplary embodiment includes electric wire groups 113a and 113b which are formed of the plurality of electric wires 11 which are provided to line up in the horizontal direction, a damming part 15B made of a resin material, and a water stop member 115. The electric wire groups 113a and 113b are disposed in two stages.

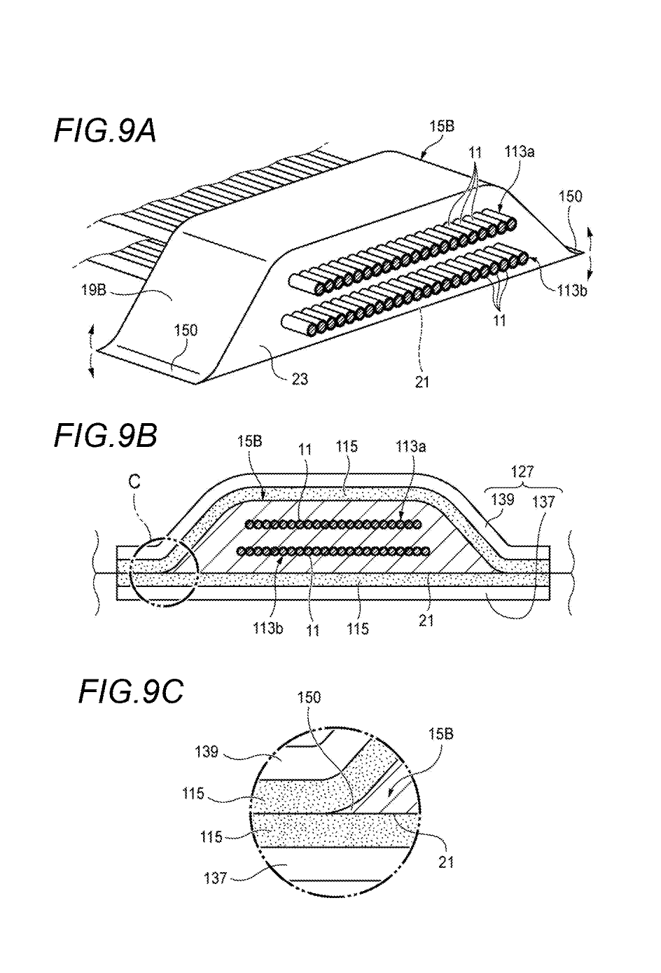

As illustrated in FIGS. 9A and 9B, the damming part 15B includes an outer periphery shape part 19B which has a trapezoidal cross section taken along a plane which is orthogonal to the extending direction of the electric wire groups 113a and 113b. In the damming part 15B, the bottom side surface of the trapezoidal cross-sectional shape is the seating surface 21, and the pair of side surfaces which face each other and interpose the seating surface 21 form the electric wire through side surfaces 23. The electric wire groups 113a and 113b penetrate the damming part 15B from one electric wire through side surface 23 toward the other electric wire through side surface 23.

Furthermore, the damming part 15B includes a thin lip piece 150 extending along a pair of sides which extend in the respective extending directions of the electric wire groups 113a and 113b from a pair of acute-angled parts of the substantially trapezoidal cross-sectional shape of the outer periphery shape part 19B.

The trapezoidal cross-sectional shape of the damming part 15B according to a trapezoidal through hole 129 in the electric wire group insertion part 127 which is illustrated in FIG. 9B. The electric wire group insertion part 127 has a divided structure which is provided in a top case (a partition wall part) 133 and a bottom case (a partition wall part) 135 of a water stop box 131. The damming part 15B of the wire harness 200 is fitted into the electric wire group insertion part 127. In other words, the wire harness 200 penetrates the partition wall part due to the damming part 15B which is fitted into the electric wire group insertion part 127.

The electric wire group insertion part 127 is formed by combining a bottom plate part 137 which is formed on the bottom case 135 and an angular rim part 139 which is formed on the top case 133 to form a tubular shape in which the trapezoidal through hole 129 is defined. In this case, the damming part 15B is interposed and fixed by the bottom plate part 137 and the angular rim part 139 by being placed on the bottom plate part 137 and subsequently being covered by the angular rim part 139. The interposing of the damming part 15B is performed by fixing with a fastener (not illustrated) which fastens the divided top case 133 and bottom case 135, or by fixing a fastener (not illustrated) which directly fastens the bottom plate part 137 and angular rim part 139.

The top case 133 and the bottom case 135 house an electronic device (not illustrated). In the wire harness 200, for example, connectors 141 which are provided in each of the two electric wire groups 113a and 113b are connected to the electronic device. The water stop box 131 is subjected to water stop countermeasures using the damming part 15B due to the damming part 15B being interposed by the electric wire group insertion part 127 in a state in which the electric wire groups 113a and 113b overlap each other vertically separated into two levels.

In the electric wire group insertion part 127, the water stop member 115 such as a seal sponge or rubber is bonded to the inner peripheral surface of the through hole 129. The water stop member 115 reliably water stops the space between the inner peripheral surface of the through hole 129 and the outer periphery shape part 19B of the damming part 15B. It is also possible to bond the water stop member 115 to the outer periphery shape part 19B of the damming part 15B.

At this time, as illustrated in FIG. 9C, the pair of water stop members 115 are overlapped along the lip piece 150 of the damming part 15B. Since the tip of this lip piece 150 is extremely thin and can be deformed so as to balance both sides by the pressure of the water stop members 115 from above and below, it becomes possible for the water stop members 115 to intersect in a state in which there is little change in the compression ratio of the water stop members 115 at a location at which the top and bottom water stop members 115 intersect. Therefore, the water stop member 115 is capable of reliably water stopping the space between the inner peripheral surface of the through hole 129 and the outer periphery shape part 19B.

It is possible to form the lip piece 150 by using parting lines of the upper mold 45 and the lower mold 47 which define the cavity 51 for molding the damming part 15B (refer to FIG. 5). Therefore, it becomes unnecessary to be concerned with mold shifting and mold alignment, and the mold 46 is easy to process.

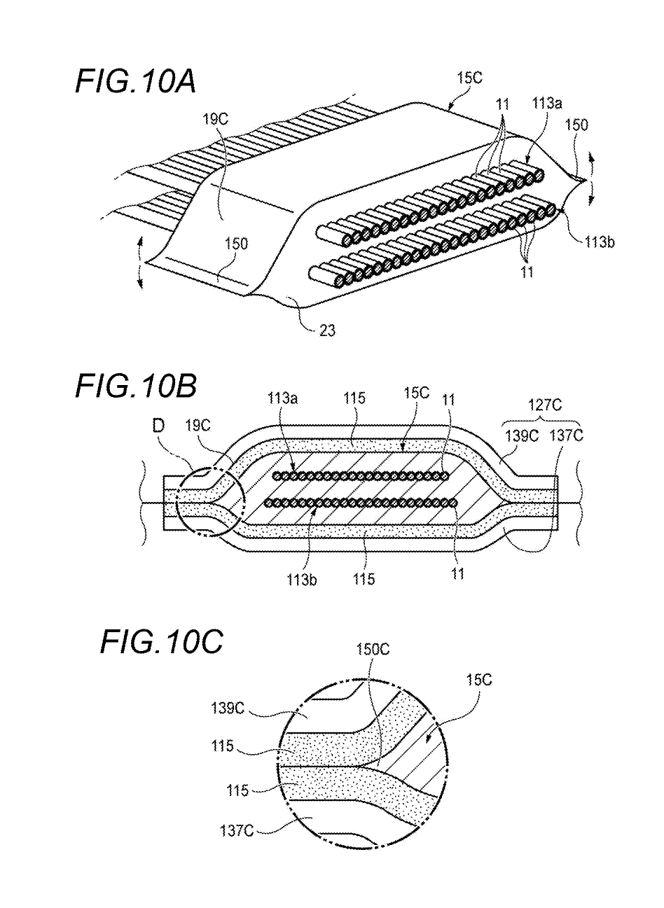

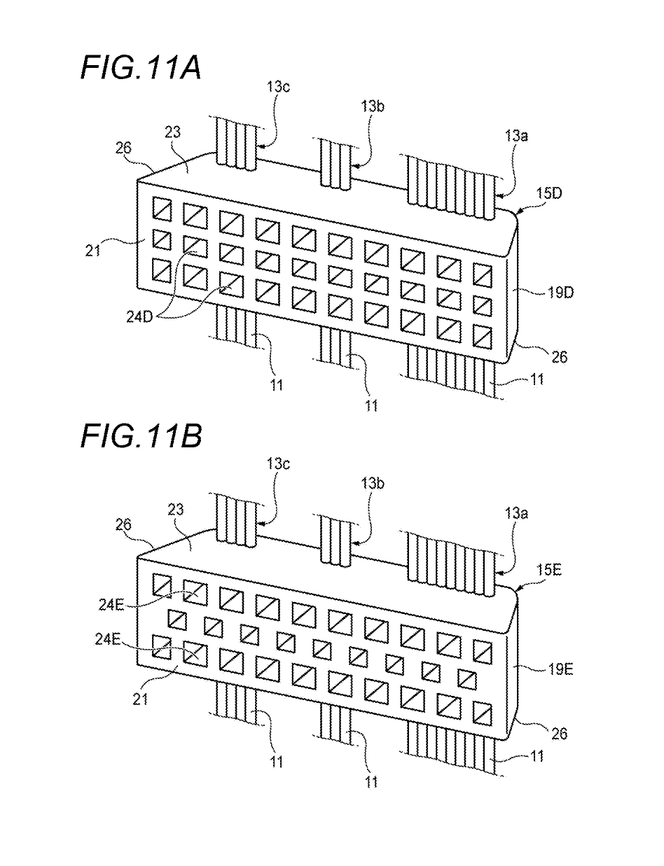

FIG. 10A is a perspective diagram illustrating a damming part 15C which is a modification example of the damming part 15B, FIG. 10B is a lateral sectional diagram of a state in which the damming part 15C illustrated in FIG. 10A is fitted into the through hole of an electric wire group insertion part 127C, and FIG. 10C is an enlarged diagram of the D part in FIG. 10B.

As illustrated in FIGS. 10A and 10B, the damming part 15C includes an outer periphery shape part 19C which has a flat hexagonal cross section taken along a plane which is orthogonal to the extending direction of the electric wire groups 113a and 113b. In the damming part 15C, both side surfaces which interpose the outer periphery shape part 19C form the electric wire through side surface 23. The electric wire groups 113a and 113b penetrate the damming part 15B from one electric wire through side surface 23 toward the other electric wire through side surface 23.

Furthermore, the damming part 15C includes the thin lip piece 150 extending along a pair of sides which extend in the respective extending directions of the electric wire groups 113a and 113b from a pair of acute-angled parts of the flat hexagonal cross-sectional shape of the outer periphery shape part 19C.

In the electric wire group insertion part 127C, the water stop member 115 is bonded to the inner peripheral surface of the through hole, and the water stop member 115 reliably water stops the space between the inner peripheral surface of the through hole and the outer periphery shape part 19C of the damming part 15C.

As illustrated in FIG. 10C, the pair of water stop members 115 are overlapped along the lip piece 150 of the damming part 15C. Since the tip of this lip piece 150 is extremely thin and can be deformed so as to balance both sides by the pressure of the water stop members 115 from above and below, it becomes possible for the water stop members 115 to intersect in a state in which there is little change in the compression ratio of the water stop members 115 at a location at which the top and bottom water stop members 115 intersect. Therefore, the water stop member 115 reliably water stops the space between the inner peripheral surface of the through hole and the outer periphery shape part 19C of the damming part 15C in the electric wire group insertion part 127C.

FIG. 11A is a perspective diagram of a damming part 15D according to the fourth exemplary embodiment of the present invention as viewed from a seating surface side, and FIG. 11B is a perspective diagram of a damming part 15E of a modification example of the damming part 15D illustrated in FIG. 11A as viewed from the seating surface side.

As illustrated in FIG. 11A, the damming part 15D according to the fourth exemplary embodiment includes an outer periphery shape part 19D which has a trapezoidal cross section taken along a plane which is orthogonal to the extending direction of the electric wire groups 13a, 13b, and 13c. In the damming part 15D, the bottom side surface of the trapezoidal cross-sectional shape is the seating surface 21. In the damming part 15D, the pair of side surfaces which face each other and interpose the seating surface 21 form electric wire through side surfaces 23. The electric wire groups 13a, 13b, and 13c penetrate the damming part 15D from one electric wire through side surface 23 toward the other electric wire through side surface 23.

In the damming part 15D of the fourth embodiment, the vicinity of a pair of edge parts 26 along the extending direction of the electric wire groups 13a, 13b, and 13c in the outer periphery shape part 19D, and two locations of the intermediate part between the pair of edge parts 26 are each formed in a trapezoidal cross-sectional shape as a part of the outer periphery shape part 19D. The pair of edge parts 26 are trapezoidal body corner parts at which an annular surface (an annular outer peripheral surface which is interposed between the pair of electric wire through side surfaces 23) of the outer periphery shape part 19D intersects each of the a pair of electric wire through side surfaces 23 which are penetrated by the electric wire groups 13a, 13b, and 13c.

The other parts in the outer periphery shape part 19D have a cross-sectional shape in which a plurality of recessed parts are formed in the bottom side of the trapezoidal cross-sectional shape. In other words, a plurality of lightening parts 24D in which a plurality of rectangular parallelepiped spaces which are linearly arranged in three rows along the edge parts 26 in the lining up direction of the electric wires 11 are recessed is formed in the seating surface 21 of the damming part 15D.

Therefore, in the mold which molds the damming part 15D, a thin pin-shaped lightening molded part for creating the lightening part 24D protrudes toward the cavity. Here, since the damming part 15D is molded using low pressure injection, there is no concern of thin pin-shaped lightening molded part deforming and breaking under the resin pressure of the molten resin.

In a damming part 15E illustrated in FIG. 11B, of the vicinity of the pair of edge parts 26 along the extending direction of the electric wire groups 13a, 13b, and 13c in an outer periphery shape part 19E, and two locations the intermediate part between the pair of edge parts 26 are each formed in a trapezoidal cross-sectional shape as a part of the outer periphery shape part 19E.

The other parts in the outer periphery shape part 19E have a cross-sectional shape in which a plurality of recessed parts are formed in the bottom side of the trapezoidal cross-sectional shape. In other words, a plurality of lightening parts 24E in which a plurality of rectangular parallelepiped spaces which are linearly arranged in three rows along the edge parts 26 in the lining up direction of the electric wires 11 are recessed in a staggered formation is formed in the seating surface 21 of the damming part 15E.

According to the damming part 15D (15E) according to the fourth embodiment, when the damming part 15D (15E) is set in the electric wire group insertion part 127 of the water stop box 131 illustrated in FIG. 8, for example, entrance of water from between the damming part 15D (15E) and the through hole 129 of the electric wire group insertion part 127 is suppressed by the outer periphery shape part 19D (19E) in the vicinity of the pair of edge parts 26 which are formed in the trapezoidal cross-sectional shape, and the two locations of the intermediate part between a pair of edge parts 26.

In the damming part 15D (15E), by reducing the volume of the thick part due to the plurality of lightening parts 24D (24E) being formed in the other parts of the outer periphery shape part 19D (19E), molding defects such as sink marks and warping arise less easily during the molding of the electric wire groups 13a, 13b, and 13c.

Therefore, for example, even in a case in which it is necessary to float the plurality of electric wire groups 13a, 13b, and 13c with respect to a vehicle body frame or the like to which the water stop box 131 is fixed, in the damming part 15D (15E) which includes the lightening part 24D (24E) in the seating surface 21, since molding defects such as sink marks and warping do not occur easily, it is possible to increase the dimension of the height direction.

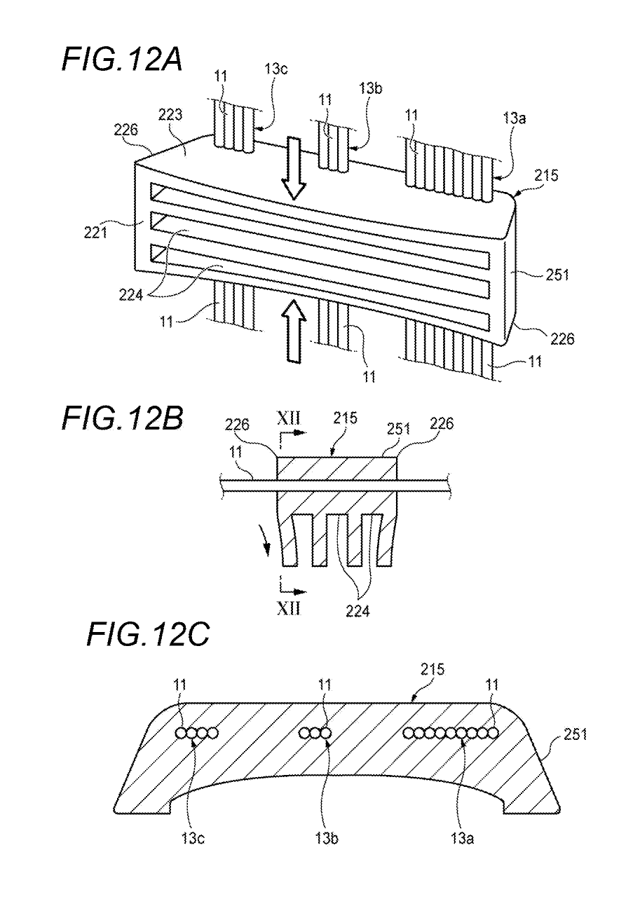

In other words, in a damming part 215 of the comparative example illustrated in FIG. 12A, the vicinity of a pair of edge parts 226 along the extending direction of the electric wire groups 13a, 13b, and 13c in an outer periphery shape part 251, and two locations of the intermediate part between the pair of edge parts 226 are each formed in a trapezoidal cross-sectional shape as a part of the outer periphery shape part 251. Three lightening parts 224 in which three deep groove spaces which are linearly arranged in three rows along the edge parts 226 in the lining up direction of the electric wires 11 are recessed is formed in a seating surface 221 of the damming part 215.

In this case, as illustrated in FIGS. 12B and 12C, deformation due to warping occurs in electric wire through side surfaces 223 and the outer periphery shape part 251 of the damming part 215. Therefore, the outer periphery shape part 251 can not evenly compress the water stop member 115 of the electric wire group insertion part 127, and the water stop member 115 reliably water stops the space between the inner peripheral surface of the through hole 129 and the outer periphery shape part 251. There is a concern that the electric wires 11 and the damming part 215 will be peeled off due to depression caused by warping which occurs in the electric wire through side surface 223 of the damming part 215.

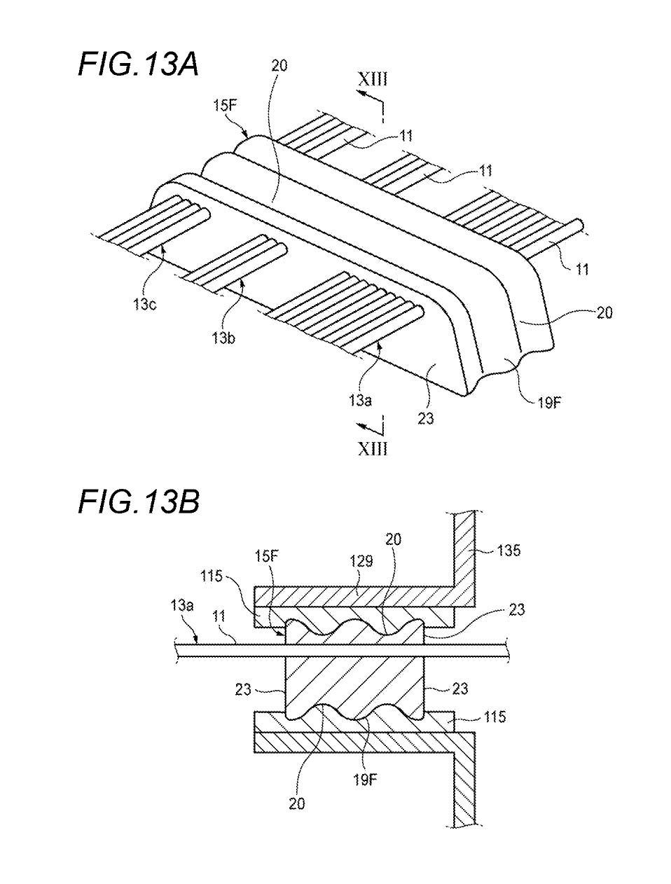

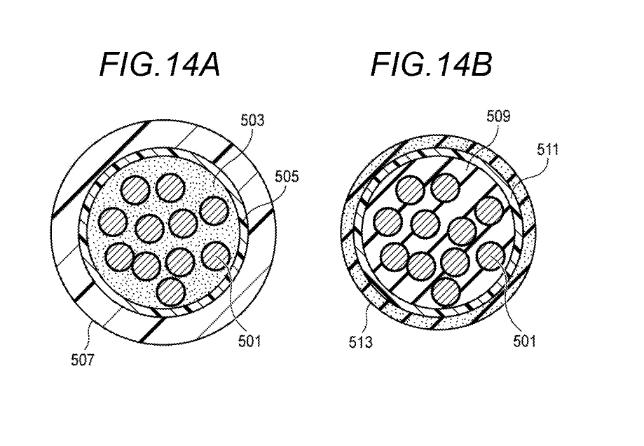

FIG. 13A is a perspective diagram of a damming part 15F according to the fifth exemplary embodiment of the present invention, and FIG. 13B is a sectional diagram of a state in which the damming part 15F illustrated in FIG. 13A is fitted into the through hole 129 of the electric wire group insertion part 127 taken along an XIII-XIII line.

As illustrated in FIG. 13A, the damming part 15F includes an outer periphery shape part 19F which surrounds a part of three rows of electric wire groups 13a, 13b, and 13c in the extending direction, and according to the inner peripheral shape of the electric wire group insertion part 127. The outer periphery shape part 19F includes a pair of annular grooves 20 which extend in the peripheral direction. In other words, as illustrated in FIG. 13B, the outer periphery shape part 19F is formed in a cross-sectional waveform shape along the extending direction of the electric wire groups 13a, 13b, and 13c.

According to the damming part 15F according to the fifth exemplary embodiment, for example, when the damming part 15F is set in the electric wire group insertion part 127 of the water stop box 131 illustrated in FIG. 8, the length of a parallel surface of the outer periphery shape part 19F which includes the annular grooves 20 which is parallel to the extending direction of the electric wire groups 13a, 13b, and 13c with respect to the water stop member 115 is increased. Therefore, time for which the entrance of water from between the damming part 15F and the through hole 129 of the electric wire group insertion part 127 can be tolerated increases, and it is possible to achieve a favorable effect on the water entrance countermeasure.

Since the annular grooves 20 which are formed in the outer periphery shape part 19F serve as a lightening part in the thick part of the damming part 15F, in the damming part 15F, molding defects such as sink marks and voids arise less easily during the molding of the electric wire groups 13a, 13b, and 13c.

Here, the characteristics of the exemplary embodiments of the manufacturing method of the wire harness according to the present invention described above are briefly summarized and listed as the following [1] to [2].

[1] A manufacturing method of a wire harness which includes at least one bundle of an electric wire group (13) in which a plurality of electric wires (11) are linearly arranged, and a damming part (15) made of a resin material, wherein the damming part surrounds a part of the electric wire group in an extending direction of the electric wire group, and wherein the damming part includes an outer periphery shape part (19) according to an inner peripheral shape of an electric wire group insertion part (29), the manufacturing method comprising:

disposing a part of the one bundle of the electric wire group in a harness housing part (57 and 59) and mold clamping an upper mold (45) and a lower mold (47) in which the harness housing part is formed on a pair of divided surfaces (the upper mold divided surface 53 and the lower mold divided surface 55); and

performing low pressure injection of a larger amount of molten resin (the molten resin 67) than a volume of a cavity (51) into the cavity, so that the resin material with which the cavity is filled protrudes from gaps between flat deburring surfaces (49) and adjacent electric wires,

wherein the harness housing part includes the cavity so as to mold the damming part and includes the flat deburring surfaces which clamp an outer periphery of the one bundle of the electric wire group at both outside end parts of the cavity which face each other in the extending direction of the electric wire group.

[2] The manufacturing method of the wire harness according to the above-described [1],

wherein the resin material includes polypropylene.

The present invention is not limited to the exemplary embodiments described above, and various modifications, improvements, and the like thereto are possible. In addition, the materials, shapes, dimensions, numbers, disposition locations, and the like of the constituent elements in the above-described exemplary embodiments are arbitrary as long as the present invention can be achieved, and are not limited.

### DESCRIPTION OF REFERENCE NUMERALS AND SIGNS

11 . . . electric wire, 13 . . . electric wire group, 15 . . . damming part, 19 . . . outer periphery shape part, 29 . . . electric wire group insertion part, 45 . . . upper mold, 47 . . . lower mold, 49 . . . deburring surface, 51 . . . cavity, 53 . . . upper mold divided surface (divided surface), 55 . . . lower mold divided surface (divided surface), 57 . . . harness housing part, 59 . . . harness housing part, 67 . . . molten resin (molten resin material).

What is claimed is:

1. A manufacturing method of a wire harness which includes at least one bundle of an electric wire group in which a plurality of electric wires are linearly arranged, and a damming part made of a resin material, wherein the damming part surrounds a part of the electric wire group in an extending direction of the electric wire group, and wherein the damming part includes an outer periphery shape part according to an inner peripheral shape of an electric wire group insertion part, the manufacturing method comprising:
disposing a part of the one bundle of the electric wire group in a harness housing part and mold clamping an upper mold and a lower mold in which the harness housing part is formed on a pair of divided surfaces; and
performing low pressure injection of a larger amount of molten resin than a volume of a cavity into the cavity, so that the resin material with which the cavity is filled protrudes from gaps between flat deburring surfaces and adjacent electric wires,
wherein the harness housing part includes the cavity so as to mold the damming part and includes the flat deburring surfaces which clamp an outer periphery of the one bundle of the electric wire group at both outside end parts of the cavity which face each other in the extending direction of the electric wire group.

2. The manufacturing method of the wire harness according to claim 1,
wherein the resin material includes polypropylene.
